(19) United States
(12) Patent Application Publication
(10) Pub. No.: US 2021/0144963 A1
(43) Pub. Date: May 20, 2021

(54) TWO-LAYER PET WATERER

(71) Applicant: SHENZHEN LIYI99.COM, LTD., Shenzhen (CN)

(72) Inventor: Xuzhong WANG, Shenzhen (CN)

(73) Assignee: SHENZHEN LIYI99.COM, LTD., Shenzhen (CN)

(21) Appl. No.: 16/739,146

(22) Filed: Jan. 10, 2020

(30) Foreign Application Priority Data
Nov. 19, 2019 (CN) 201921996086.2

(51) Int. Cl. A01K 7/02; C02F 1/00; C02F 1/28; C02F 1/42

(52) U.S. Cl. CPC A01K 7/025; C02F 1/001; C02F 1/283; C02F 2103/20; C02F 2001/425; C02F 2209/42; C02F 2209/40; C02F 1/42

(57) ABSTRACT

The present invention discloses a two-layer pet waterer. The two-layer pet waterer comprises a water tank and a first drinking plate arranged above the water tank, and a fountain opening is connected with the bottom of the first drinking plate. The fountain opening is connected with a water pipe, and the water pipe is connected with a low-water-level pump. A second drinking plate is arranged below the first drinking plate. The low-water-level pump pumps water into the first drinking plate, and after the water is full of the first drinking plate, it leaks into the second drinking plate. A pet can choose the first drinking plate or the second drinking plate by itself to drink the water.

### TECHNICAL FIELD

The present invention relates to a pet waterer, which is special for pets, and belongs to the technical fields of pet supplies.

### BACKGROUND

The existing pet waterer can be classified into a waterer for small pets and a waterer for medium and large pets.

The waterer for small pets utilizes a special water pump to pump water into a drinking plate, and the water is filtered by a filter element and then flows back to a water tank so as to form a circulation of the water. Therefore, the pet can drink clean water. Furthermore, pet hairs and food residues are left in the filter element and do not flow back to the water tank. Therefore, the waterer for the small pets has the advantages that water drunk by the pets is filtered, the form of a nozzle is diverse, and the water is discharged in various manners, which can attract more attention of the pets to a certain degree so as to increase the water drinking times of the pets. However, the waterer for the small pets has the disadvantages that the water storage area of a drinking plate is very small, and the water storage capacity of the water tank is small, so such waterer is only suitable for small pets. Additionally, such waterer is relatively high so that the pet needs to put its front paws on the edge of the waterer when drinking the water.

The waterer for medium and large pets uses one container as the drinking plate and the water tank such that the water drinking area is large and can meet a requirement that the medium and large pets need to drink a lot of water. The waterer for medium and large pets similarly uses a special pump to pump water, and the water is sprayed out through a water outlet and then flows back to the drinking plate. Additionally, a water drinking position is relatively low. The drinking plate and the water tank are the same container, so, even if there is a filtering system, the pet hairs and the food residues still are always left in the drinking plate, and a user can see these hairs and food residues so that the user needs to change the water frequently.

### SUMMARY

A technical problem to be solved by the present invention is to increase a water drinking area for the pet and a water storage capacity of a drinking plate in order to meet the water drinking requirement of medium and large pets.

To solve the above-mentioned technical problems, the present invention adopts the following technical solution:

A two-layer pet waterer comprises a water tank (7) and a first drinking plate (1) arranged above the water tank (7). A fountain opening (2) is connected with the bottom of the first drinking plate (1). The fountain opening (2) is connected with a water pipe, and the water pipe is connected with a low-water-level pump (11). A second drinking plate (4) is arranged below the first drinking plate (1). The low-water-level pump (11) pumps water into the first drinking plate (1), and after the water is full of the first drinking plate (1), it leaks into the second drinking plate (4). A pet can choose the first drinking plate (1) or the second drinking plate (4) by itself to drink the water.

Preferably, a polypropylene (PP) cotton (10) is arranged at the bottom of the low-water-level pump (11).

Preferably, an overflow hole (3) is arranged in a side wall of the second drinking plate (4). When the water level of the second drinking plate (4) is higher than the overflow hole (3), the water leaks into a filter element frame (5) to be filtered by a filter element (6) and then flows into the water tank (7), and the water in the water tank (7) is pumped into the first drinking plate (1) again through the low-water-level pump (11) so as to form a circulation of the water.

Preferably, the low-water-level pump (11) automatically stops operating and an LED lamp flashes at the same time when the water level is too low.

Preferably, transparent windows (8) are arranged at side portions of the water tank (7), and a user can intuitively see the flashing LED lamp and the water level through the transparent windows (8).

Preferably, a plurality of foot pads (9) are arranged at the bottom of the water tank (7).

Preferably, the filter element (6) comprises a filter element bottom shell having a hollow structure, multiple cation exchange resin pouches (12) and coconut shell activated carbon pouches (13) are arranged in the filter element, and a filter element lid (14) is arranged at the top of the filter element and covers the filter element bottom shell.

After the present invention adopts the above technical solution, the water drinking area for the pet and the water storage capacity of the drinking plate are increased and can meet the water drinking requirement of the medium and large pets.

Furthermore, two layers of the drinking plates are designed, and the drinking plates have different heights, so the small, medium and large pets can choose a proper drinking plate to drink the water according to their heights.

Moreover, the water drunk by the pets is filtered, all hairs and impurity grains are filtered by the filter element, and by virtue of a special buffering design of the filter element frame, the sound of the water flowing through the filter element can be reduced to the lowest.

Other features and advantages of the present invention will be described in the following specification, and some of these will become apparent from the description or be understood by implementing the present invention. The objectives and other advantages of the present invention can be implemented or obtained by structures specifically indicated in the written specification, claims, and accompanying drawings.

### BRIEF DESCRIPTION OF THE DRAWINGS

To make the foregoing advantages of the present invention clearer, the present invention is described in detail below with reference to the accompanying drawings.

FIG. 1 is a schematic diagram of a two-layer pet waterer of the present invention.

FIG. 2 is an exploded view of the two-layer pet waterer of the present invention.

FIG. 3 is a sectional view of the two-layer pet waterer of the present invention.

FIG. 4 is a diagram of a filter element frame of the two-layer pet waterer of the present invention.

FIG. 5 is a sectional view of the filter element frame of the two-layer pet waterer of the present invention.

FIG. 6 is an exploded view of a filter element of the two-layer pet waterer of the present invention.

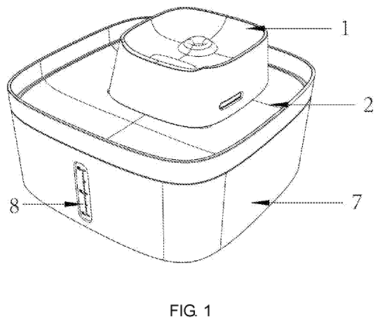

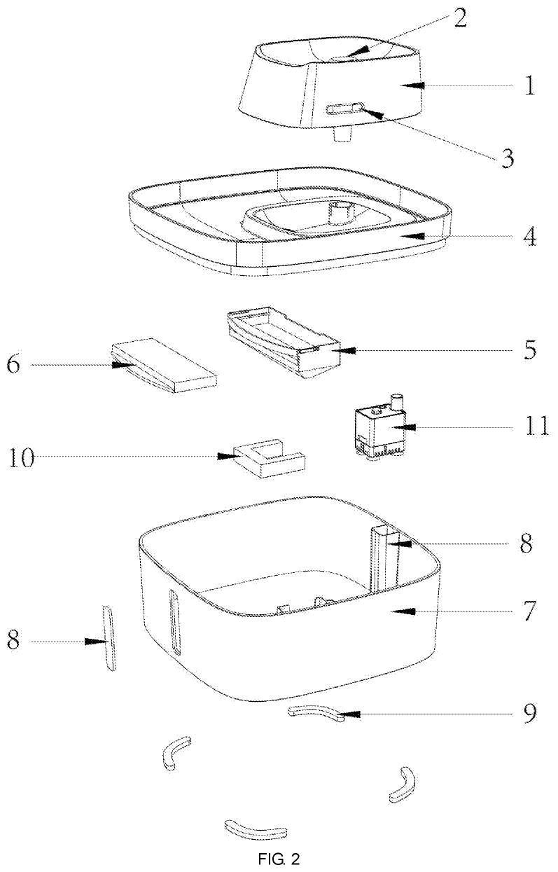

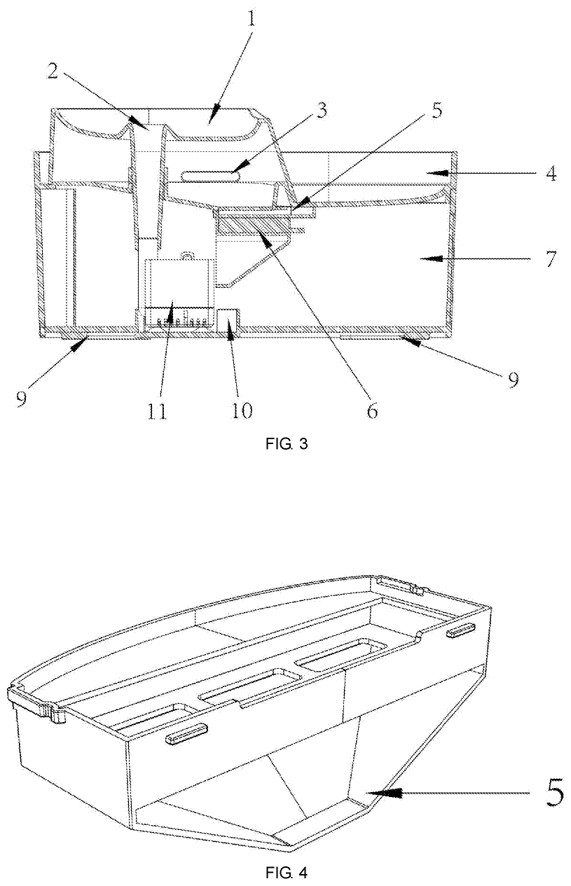

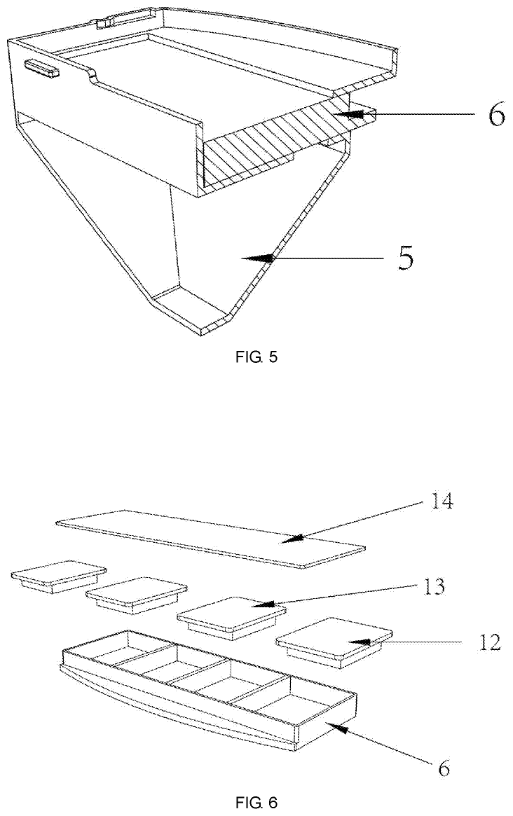

### DESCRIPTION OF THE EMBODIMENTS

The following describes the present invention in detail with reference to the specific embodiments.

Specifically, a two-layer pet waterer provided by the present invention comprises a first drinking plate (1), a fountain opening (2), an overflow hole (3), a second drinking plate (4), a filter element frame (5), a filter element (6), a water tank (7), transparent windows (8), foot pads (9), a PP cotton (10), an intelligent low-water-level pump (11), cation exchange resin pouches (12) and coconut shell activated carbon pouches (13).

The first drinking plate (1) is arranged above the water tank (7). The fountain opening (2) is connected with the bottom of the first drinking plate (1). The fountain opening (2) is connected with a water pipe, and the water pipe is connected with the low-water-level pump (11). The second drinking plate (4) is arranged below the first drinking plate (1). The low-water-level pump (11) pumps water into the first drinking plate (1), and after the water is full of the first drinking plate (1), it leaks into the second drinking plate (4). A pet can choose the first drinking plate (1) or the second drinking plate (4) by itself to drink the water.

Preferably, the PP cotton (10) is arranged at the bottom of the low-water-level pump (11).

Preferably, the overflow hole (3) is arranged in a side wall of the second drinking plate (4). When the water level of the second drinking plate (4) is higher than the overflow hole (3), the water leaks into the filter element frame (5) to be filtered by the filter element (6) and then flows into the water tank (7), and the water in the water tank (7) is pumped into the first drinking plate (1) again through the low-water-level pump (11) so as to form a circulation of the water.

Preferably, the low-water-level pump (11) automatically stops operating and an LED lamp flashes at the same time when the water level is too low.

Preferably, the transparent windows (8) are arranged at side portions of the water tank (7), and a user can intuitively see the flashing LED lamp and the water level through the transparent windows (8).

Preferably, a plurality of the foot pads (9) are arranged at the bottom of the water tank (7).

Preferably, the filter element (6) comprises a filter element bottom shell having a hollow structure, the multiple cation exchange resin pouches (12) and the coconut shell activated carbon pouches (13) are arranged in the filter element, and a filter element lid (14) is arranged at the top of the filter element and covers the filter element bottom shell.

After the present invention adopts the above technical solution, the water drinking area for the pet and the water storage capacity of the drinking plate are increased and can meet the water drinking requirement of the medium and large pets.

Furthermore, two layers of the drinking plates are designed, and the drinking plates have different heights, so the small, medium and large pets can choose a proper drinking plate to drink the water according to their heights.

Moreover, the water drunk by the pets is filtered, all hairs and impurity grains are filtered by the filter element, and by virtue of a special buffering design of the filter element frame, the sound of the water flowing through the filter element can be reduced to the lowest.

In a specific embodiment, the two-layer pet waterer is fabricated by plastic. The low-water-level pump (11) pumps the water into the first drinking plate (1), and after the water is full of the first drinking plate (1), it leaks into the second drinking plate (4). When the water level of the second drinking plate is higher than the overflow hole (3), the water leaks into the filter element frame (5) to be filtered by the filter element (6) and then flows into the water tank (7), and the water in the water tank (7) is pumped into the first drinking plate (1) again through the low-water-level pump (11) so as to form a circulation of the water. The pet can choose the first drinking plate (1) or the second drinking plate (4) by itself to drink the water. The water storage capacity and the water drinking area of the two drinking plates are sufficiently large and can meet the water drinking requirements of different types of the medium and large pets, so that the pets may be more healthy. When the low-water-level pump (11) is utilized, the utilization rate of the water in the water tank is largely increased. The low-water-level pump (11) automatically stops operating and the LED lamp flashes at the same time when the water level is too low. A user can intuitively see the flashing LED lamp and the water level through the transparent windows (8) so as to remind of water adding.

According to the two-layer pet waterer of the present invention, the drinking plate has sufficiently large water storage capacity and area, which can meet the water drinking requirement of the medium and large pets; the water drunk by the pets are filtered by the filter element so as to be clean and safe. Two layers of the drinking plates are designed so that the pets can choose a proper drinking position according to its height. The special pump can automatically power off when the water is insufficient and can automatically restart operating when the water is added. Additionally, the LED lamp flashes to remind the user to add water, so product experience is excellent.

The two-layer pet waterer of the present invention is fabricated by utilizing environmental-friendly food-level plastic, does not cause any damage to the pets and is safe and convenient.

Finally, it should be noted that the foregoing embodiment is merely a preferred embodiment of the present invention, but not for limiting the present invention. Although the present invention is described in detail with reference to the foregoing embodiment, persons skilled in the art may still make modifications to the technical solution described in the foregoing embodiment or make equivalent substitutions to some technical features thereof. Any modifications, equivalent substitutions, improvements, and the like within the spirit and principles of the present invention are intended to be included within the protection scope of the present invention.

What is claimed is:

1. A two-layer pet waterer, comprising a water tank and a first drinking plate arranged above the water tank, wherein a fountain opening is connected with the bottom of the first drinking plate; the fountain opening is connected with a water pipe, and the water pipe is connected with a low-water-level pump; a second drinking plate is arranged below the first drinking plate; the low-water-level pump is configured for pumping water into the first drinking plate, and after the water is full of the first drinking plate, the water leaks into the second drinking plate; a pet can choose the first drinking plate or the second drinking plate by itself to drink the water.

2. The two-layer pet waterer according to claim 1, wherein a polypropylene cotton is arranged at the bottom of the low-water-level pump.

3. The two-layer pet waterer according to claim 1, wherein an overflow hole is arranged in a side wall of the second drinking plate; when the water level of the second drinking plate is higher than the overflow hole, the water leaks into a filter element frame to be filtered by a filter element and then flows into the water tank, and the water in the water tank is pumped into the first drinking plate again through the low-water-level pump so as to form a circulation of the water.

4. The two-layer pet waterer according to claim 1, wherein the low-water-level pump automatically stops operating and an LED lamp flashes at the same time when the water level is too low.

5. The two-layer pet waterer according to claim 1, wherein transparent windows are arranged at side portions of the water tank, and a user can see the flashing LED lamp and the water level through the transparent windows.

6. The two-layer pet waterer according to claim 1, wherein a plurality of foot pads are arranged at the bottom of the water tank.

7. The two-layer pet waterer according to claim 3, wherein the filter element comprises a filter element bottom shell having a hollow structure, multiple cation exchange resin pouches and coconut shell activated carbon pouches are arranged in the filter element, and a filter element lid is arranged at the top of the filter element and covers the filter element bottom shell.

8. The two-layer pet waterer according to claim 2, wherein an overflow hole is arranged in a side wall of the second drinking plate; when the water level of the second drinking plate is higher than the overflow hole, the water leaks into a filter element frame to be filtered by a filter element and then flows into the water tank, and the water in the water tank is pumped into the first drinking plate again through the low-water-level pump so as to form a circulation of the water.

9. The two-layer pet waterer according to claim 8, wherein the filter element comprises a filter element bottom shell having a hollow structure, multiple cation exchange resin pouches and coconut shell activated carbon pouches are arranged in the filter element, and a filter element lid is arranged at the top of the filter element and covers the filter element bottom shell
